(19) United States
(12) Patent Application Publication
(10) Pub. No.: US 2025/0103415 A1
(43) Pub. Date: Mar. 27, 2025

(54) EDITING SUPPORT DEVICE, EDITING SUPPORT METHOD, AND EDITING SUPPORT PROGRAM

(71) Applicant: Nippon Telegraph and Telephone Corporation, Tokyo (JP)

(72) Inventors: Fumihiro YOKOSE, Musashino-shi, Tokyo (JP); Kimio TSUCHIKAWA, Musashino-shi, Tokyo (JP); Taisuke WAKASUGI, Musashino-shi, Tokyo (JP); Yuki URABE, Musashino-shi, Tokyo (JP); Ryo UCHIDA, Musashino-shi, Tokyo (JP); Haruo OISHI, Musashino-shi, Tokyo (JP)

(21) Appl. No.: 18/728,968

(22) PCT Filed: Jan. 26, 2022
(86) PCT No.: PCT/JP2022/002938

§ 371 Date: Jul. 15, 2024

(51) Int. Cl. G06F 11/07

(52) U.S. Cl. CPC G06F 11/0766; G06F 11/0709

(57) ABSTRACT

An editing support device accepts input of operation flow indicating a series of operations on a computer by nodes indicating the operations and an edge connecting the nodes. Next, the editing support device determines whether or not a nested state of a control structure of the operation flow is incomplete on the basis of a connection relationship between the nodes of the operation flow. Here, in a case where the nested state of the control structure of the operation flow is incomplete, the editing support device determines that an error is included in the operation flow and specifies a node that is a cause of the error in the operation flow as an error node. Then, the editing support device outputs information on the specified error node.

### TECHNICAL FIELD

The present invention relates to an editing support device, an editing support method, and an editing support program.

### BACKGROUND ART

In related art, there is process analysis software that supports creation of a scenario of robotics process automation (RPA) by acquiring a log on a PC and analyzing flow (process) of operation of business.

### CITATION LIST

### Non Patent Literature

Non Patent Literature 1: NTT Technical Journal, DX suishin ni koken suru gyomu kashika gijutsu (in Japanese) (Business Visualization Technology Contributing to DX Promotion), [online], [searched on Jan. 17, 2022], Internet <https://journal.ntt.co.jp/wp-content/uploads/2020/05/JN20200272.pdf>
Non Patent Literature 2: NTT Technical Journal, Anka/Jinsoku ni gyomu koritsuka wo jitsugen suru “Tanmatsu sosa jidoka tool UMS” (in Japanese) (“Terminal Manipulation Automation Tool UMS” that Achieves Efficiency of Business at Low Cost and Promptly), [online], [searched on Jan. 17, 2022], Internet <URL: https://journal.ntt.co.jp/backnumber2/1312/files/jn201312030.pdf>

### SUMMARY OF INVENTION

### Technical Problem

In many cases, process analysis software can freely create flow that can be expressed using a flowchart without limitation, Thus, for example, operation flow created on the process analysis software may include flow corresponding to goto. Here, in an RPA product, or the like, using operation flow information, there may be a constraint on operation flow that can be input. Thus, even if the operation flow created by the process analysis software is directly input to the RPA product, there is a case where the operation flow cannot be converted into an RPA scenario.

For example, if there is incomplete nested structure flow (for example, flow including the above-described goto, and the like,) in the operation flow created by the process analysis software, it may not be possible to convert the operation flow to an RPA scenario even if the operation flow is input to the RPA product.

In such a case, a user needs to modify the operation flow to meet the constraint of the RPA scenario, but it is difficult for a user who is not a software developer to modify the operation flow to meet the constraint of the RPA scenario.

It is therefore an object of the present invention to make it easy for a user to modify operation flow so as to meet a constraint of an RPA scenario.

### Solution to Problem

In order to solve the above problem, the present invention includes: an input acceptance unit that accepts input of operation flow indicating a series of operations on a computer by nodes indicating the operations and an edge connecting the nodes, a determination unit that determines whether or not a nested state of a control structure of the operation flow is in an incomplete state on the basis of a connection relationship between the nodes of the operation flow and determines that an error is included in the operation flow in a case where it is determined that the nested state is in the incomplete state, and an error output unit that, in a case where it is determined that an error is included in the operation flow, specifies a node that is a cause of the error in the operation flow as an error node and outputs information on the specified error node.

According to the present invention, it is possible to make it easy for a user to modify operation flow to meet a constraint of an RPA scenario.

### BRIEF DESCRIPTION OF DRAWINGS

FIG. 1 is a view for explaining outline of an editing support device.

FIG. 2 is a view for explaining the outline of the editing support device.

FIG. 3 is a view illustrating an example of a flowchart in which a nested state of a control structure is complete,

FIG. 4 is a view illustrating a configuration example of the editing support device.

FIG. 5 is a view illustrating an example of an edge information table and a node information table.

FIG. 6 is a view illustrating an example of node individual constraint information.

FIG. 7 is a flowchart illustrating an example of processing procedure by a determination unit.

FIG. 8 is a flowchart illustrating an example of processing procedure of checking a node individual constraint by the determination unit.

FIG. 9 is a view illustrating an example of a temporary information table.

FIG. 10 is a view illustrating a detection example of a start/end combination abnormality error.

FIG. 11 is a view illustrating a detection example of a nesting abnormality error.

FIG. 12 is a view illustrating a detection example of a backward error.

FIG. 13 is a flowchart illustrating an example of processing procedure of checking a constraint of a node relationship by the determination unit.

FIG. 14 is a flowchart illustrating an example of processing procedure of checking the constraint of the node relationship by the determination unit.

FIG. 15 is a view illustrating a detection example of the start/end combination abnormality error.

FIG. 16 is a view illustrating a detection example of the start/end combination abnormality error.

FIG. 17 is a flowchart illustrating an example of processing procedure of checking the constraint of the node relationship by the determination unit.

FIG. 18 is a flowchart illustrating an example of processing procedure of checking the constraint of the node relationship by the determination unit.

FIG. 19 is a flowchart illustrating an example of processing procedure of checking the constraint of the node relationship by the determination unit.

FIG. 20 is a view illustrating a detection example of the start/end combination abnormality error.

FIG. 21 is a flowchart illustrating 21 an example of processing procedure of checking the constraint of the node relationship by the determination unit.

FIG. 22 is a view illustrating an example of the node individual constraint information.

FIG. 23 is a view illustrating a configuration example of a computer that executes an editing support program.

### DESCRIPTION OF EMBODIMENTS

Hereinafter, a mode for carrying out the present invention (embodiment) will be described with reference to the drawings. The present invention is not limited to the present embodiment.

### Outline

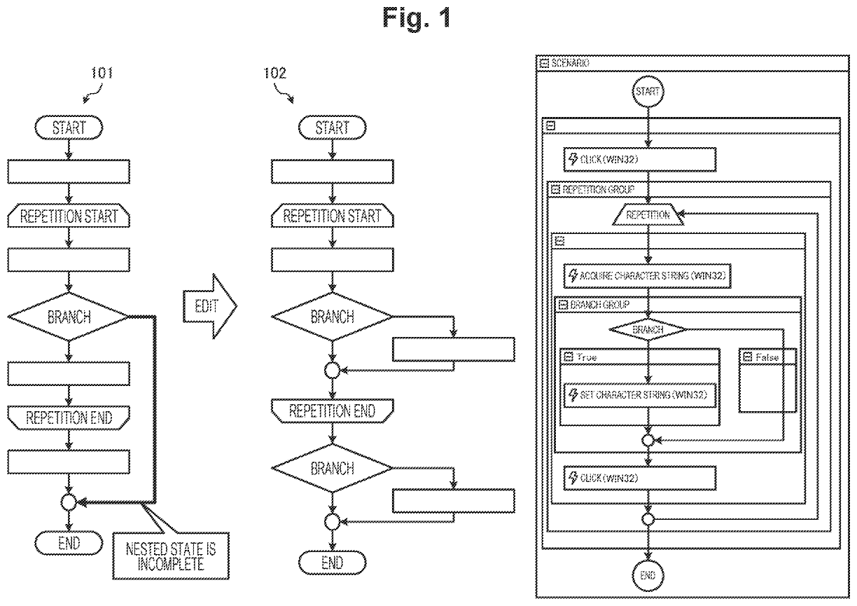

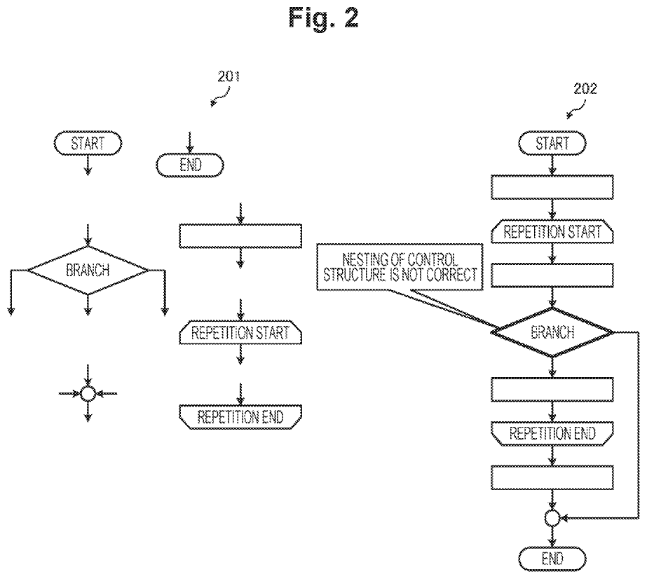

First, outline of an editing support device of the present embodiment will be described with reference to FIGS. 1 and 2. For example, it is difficult for a user who is not an expert in software to edit a flowchart in which a nested state of a control structure is incomplete as indicated by a reference numeral 101 in FIG. 1 into a flowchart in which the nested state of the control structure is complete as indicated by a reference numeral 102.

Thus, the editing support device of the present embodiment supports a user who is not an expert in software to edit a flowchart into a flowchart in which the nested state of the control structure is complete.

For example, the editing support device first determines whether or not respective nodes satisfy constraint conditions (for example, conditions of the number of input edges to the node and the number of output edges from the node) for each individual node on the basis of types (for example, branch, repetition start, repetition end, and the like) of the respective nodes constituting a flowchart as indicated by a reference numeral 201 in FIG. 2. Thereafter, the editing support device determines whether or not each node satisfies constraint conditions of a connection relationship between nodes on the basis of a connection relationship between nodes as indicated by a reference numeral 202. Then, in a case where the editing support device finds a node not satisfying the above-described constraint conditions, the editing support device outputs, for example, an error message (see a reference numeral 202) indicating a cause of the error, or the like, to the node.

As a result, the user can know that the nested state of the control structure in the flowchart is incomplete and the cause portion thereof. Furthermore, in this event, the editing support device displays the cause portion of the error, or the like, so that the user can determine what kind of editing should be performed on the cause of the error in order to bring the nested state of the flowchart into a complete state.

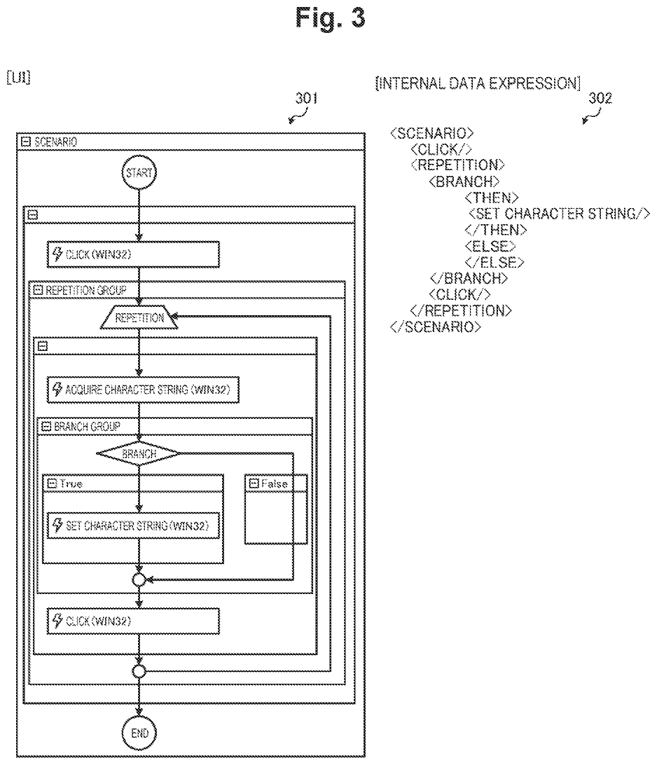

Note that the flowchart in which the nested state (hereinafter, also referred to as a “nested structure” as appropriate) of the control structure is complete is, for example, a flowchart having a UI as indicated by a reference numeral 301 in FIG. 3. Internal data expression of this flowchart is expressed by XML as indicated by a reference numeral 302.

Note that, in the embodiment described below, a target to be checked by the editing support device as to whether or not the state is a nested state is “branch (branch start to branch end)” and “repetition (repetition start to repetition end)” in the operation flow, but the present invention is not limited thereto. For example, another control structure from the start to the end of the operation flow may be targeted.

### Configuration Example

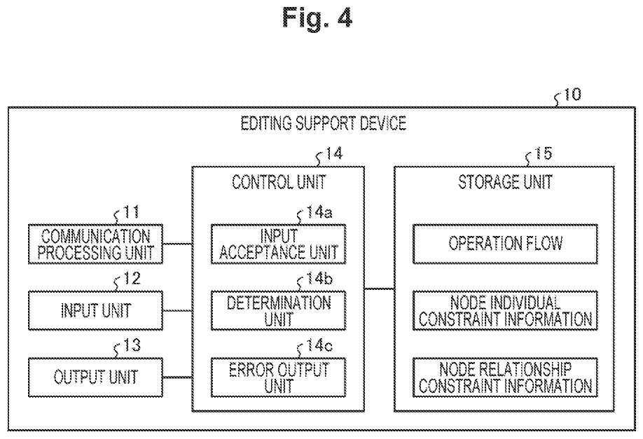

Next, a configuration example of the editing support device will be described with reference to FIG. 4. An editing support device 10 is implemented by, for example, a general-purpose computer such as a PC. For example, as illustrated in FIG. 4, the editing support device 10 includes a communication processing unit 11, an input unit 12, an output unit 13, a control unit 14, and a storage unit 15.

The communication processing unit 11 is implemented by a network interface card (NIC) or the like, and controls communication between an external device and the control unit 14 via a telecommunication line such as a local area network (LAN) or the Internet. For example, the communication processing unit 11 receives operation flow to be processed from the external device.

The input unit 12 is an interface that accepts input of various types of information from an input device such as a keyboard and a mouse. The output unit 13 is an interface for outputting output information from the control unit 14 to a display device such as a liquid crystal display.

The storage unit 15 stores data and programs necessary for various types of processing by the control unit 14. For example, the storage unit 15 is a semiconductor memory element such as a random access memory (RAM) or a flash memory, or a storage device such as a hard disk or an optical disk.

The storage unit 15 stores, for example, operation flow, node individual constraint information, node relationship constraint information, and the like. The operation flow is, for example, information indicating a series of operations on the computer with nodes indicating the operations and an edge connecting the nodes.

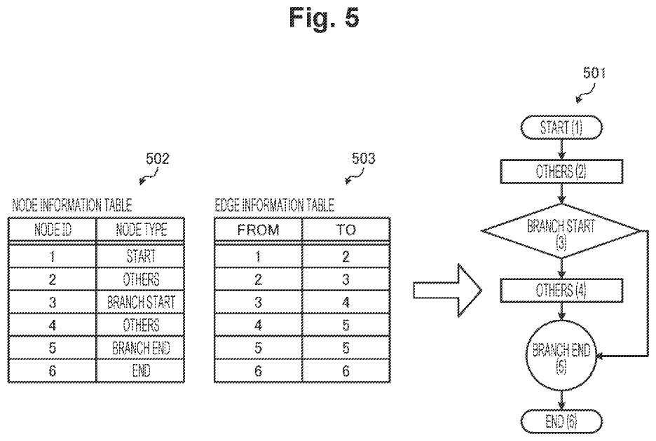

For example, as illustrated in FIG. 5, the operation flow is expressed by a combination of a node information table (see a reference numeral 502) and an edge information table (see a reference numeral 503).

The node information table is, for example, as indicated by the reference numeral 502, information indicating node IDs of the nodes constituting the operation flow and types of the nodes. In addition, the edge information table is, for example, as indicated by the reference numeral 503, information indicating an edge from which node with a node ID to which node with a node ID exists in the operation flow. For example, the edge information table indicated by the reference numeral 503 indicates that there are an edge from the node ID “1” to the node ID “2”, an edge from the node ID “2” to the node ID “3”, an edge from the node ID “3” to the node ID “4”, and the like, in the operation flow.

Note that each of the node information table and the edge information table may include information other than the information illustrated in FIG. 5.

The description returns to FIG. 4. The node individual constraint information is information indicating the constraint of the node of the type for each type of node.

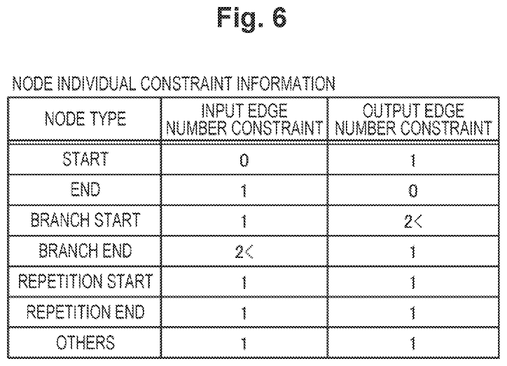

For example, as illustrated in FIG. 6, the node individual constraint information is information indicating a constraint on the number of input edges (input edge number constraint) and a constraint on the number of output edges (output edge number constraint) for each type of node. For example, in the node individual constraint information illustrated in FIG. 6, it is indicated that the number of input edges of the start node is constrained to “0” and the number of output edges is constrained to “1”. In addition, the number of input edges of the branch start node is constrained to “1”, and the number of output edges is constrained to “2 or more”.

The node individual constraint information is referred to when the control unit 14 determines whether or not each node of the operation flow satisfies the constraint conditions of an individual node.

The description returns to FIG. 4. The node relationship constraint information is information indicating a constraint on a connection relationship between nodes. The node relationship constraint information is referred to when the control unit 14 determines whether or not constraint conditions regarding a connection relationship between nodes constituting the operation flow are satisfied. Details of the determination processing as to whether or not the constraint conditions regarding the connection relationship between the nodes are satisfied with reference to the node relationship constraint information will be described later using a specific example.

The control unit 14 includes an internal memory that stores programs defining various types of processing procedure, and the like, and data and executes various types of processing using the programs and the data. For example, the control unit 14 includes an input acceptance unit 14a, a determination unit 14b, and an error output unit 14c. Here, the control unit 14 is an electronic circuit such as a central processing unit (CPU) and a micro processing unit (MPU), or an integrated circuit such as an application specific integrated circuit (ASIC) and a field programmable gate array (FPGA).

The input acceptance unit 14a accepts input of operation flow to be processed via the input unit 12. The accepted operation flow is stored in the storage unit 15.

The determination unit 14b determines whether or not an error is included in the operation flow. For example, the determination unit 14b determines whether or not each node of the operation flow satisfies the constraint conditions of an individual node with reference to the node individual constraint information (see FIG. 6).

For example, the determination unit 14b refers to the node individual constraint information and determines, for each of nodes constituting the operation flow, whether or not the number of input edges and the number of output edges permitted for the node are satisfied on the basis of the type of the node.

Then, in a case where the determination unit 14b determines that there is a node that does not satisfy the number of input edges and the number of output edges permitted for the node in the operation flow, it is determined that an error is included in the operation flow. Then, the error output unit 14c specifies a node that does not satisfy the number of input edges and the number of output edges permitted for the node as an error node and outputs the error node.

In addition, the determination unit 14b refers to the node relationship constraint information and determines whether or not the operation flow satisfies the constraint conditions regarding the connection relationship between the nodes.

For example, the determination unit 14b determines whether or not a nested state of the control structure of the operation flow is incomplete with reference to the node relationship constraint information. Note that the state in which nesting of the control structure of the operation flow is incomplete is, for example, a state in which the operation flow includes an edge corresponding to goto. For example, in a case where the operation flow includes an edge corresponding to goto, the determination unit 14b determines that nesting of the control structure is incomplete. Note that errors caused by the operation flow including the edge corresponding to goto include a nesting abnormality error and a backward error.

In a case where it is determined that the nesting of the control structure of the operation flow is not incomplete, the determination unit 14b determines that a nesting abnormality error is included in the operation flow. Then, the error output unit 14c specifies a node that is a cause of the nesting abnormality error as an error node and outputs the error node.

Furthermore, for example, in a case where the determination unit 14b determines that the operation flow includes a backward error on the basis of the constraint conditions on the connection relationship between the nodes, the determination unit 14b determines that the backward error is included in the operation flow. Then, the error output unit 14c specifies a node that is a cause of the backward error as an error node and outputs the error node.

Furthermore, for example, in a case where the determination unit 14b determines that the operation flow is not terminated on the basis of the constraint conditions on the connection relationship between the nodes, it is determined that the operation flow includes a start/end combination abnormality error. Then, the error output unit 14c specifies a node that is a cause of the start/end combination abnormality error as an error node and outputs the error node.

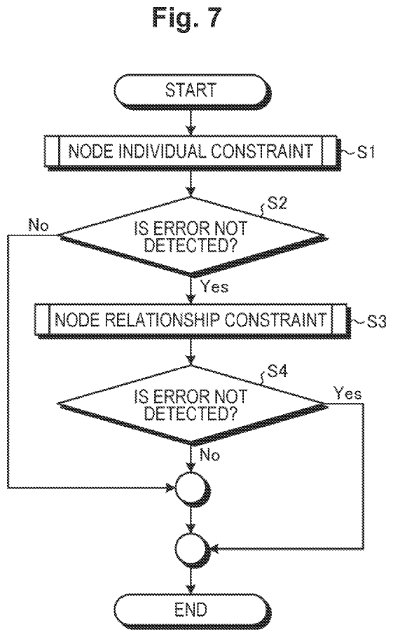

An example of processing procedure by the determination unit 14b will be described with reference to FIG. 7. For example, as illustrated in FIG. 7, the determination unit 14b executes check flow including two stages as a whole (check flow of the node individual constraint and check flow of the node relationship constraint). Then, in a case where an error is found in any check flow, the determination unit 14b terminates the check. This is because if an error is found in the first check flow, the error is also found in the subsequent check flow.

For example, as illustrated in FIG. 7, the determination unit 14b first checks the node individual constraint (S1), and if an error is detected (S2: No), outputs an error regarding the constraint of the individual node and ends the processing.

On the other hand, if no error is detected (S2: Yes), the determination unit 14b checks the constraint on the node relationship (S3), and if an error is detected (S4: No), the determination unit 14b outputs an error regarding the constraint on the node relationship and ends the processing. On the other hand, if no error is detected (S4: Yes), the processing ends as it is.

As described above, in a case where an error is found in the constraint check flow of the individual node, the determination unit 14b terminates the check at that point. As a result, in a case where a plurality of errors is included in the operation flow, the determination unit 14b sequentially outputs the errors from the error in the previous stage, so that the user can easily resolve the errors.

The description returns to FIG. 4. The error output unit 14c outputs information on a node determined as an error by the determination unit 14b among the nodes constituting the operation flow.

For example, the error output unit 14c specifies, as error nodes, a node determined by the determination unit 14b not to satisfy the constraint conditions of the individual node (for example, a node that does not satisfy the number of input edges and the number of output edges permitted to the node) and a node determined not to satisfy the constraint of the node relationship, and outputs information on the error nodes.

In addition, the error output unit 14c may further output information indicating causes of the errors when outputting the information on the error nodes.

For example, in a case where the error node is a branch node and a cause of the error is that the end of the branch flow is incorrect, the error output unit 14c displays an error message such as “end of the branch flow is incorrect” after displaying the branch node in the operation flow in a state distinguishable from other nodes as indicated by the reference numeral 201 in FIG. 2.

The error output unit 14c displays the error on the operation flow, and thus, the user can easily determine what kind of correction (editing) should be performed on which node in order to resolve the error in the flowchart.

Next, details of check of the constraint of the individual node and check of the constraint of the node relationship to be performed by the determination unit 14b will be described using specific examples.

### [Check of Constraint of Individual Node]

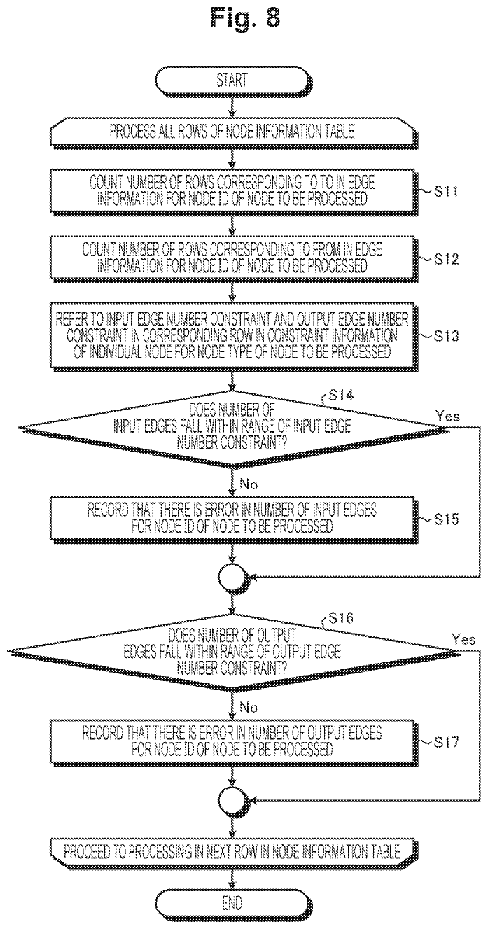

First, a specific example of check of the constraint of the individual node by the determination unit 14b will be described with reference to FIG. 8. For example, the determination unit 14b uses the node individual constraint information (see FIG. 6), the node information table, and the edge information table (see FIG. 5) to check whether or not each node of the operation flow satisfies the constraint of the individual node by the following processing procedure. The determination unit 14b executes the following processing on all rows of the node information table.

First, the determination unit 14b counts the number of rows (the number of input edges) corresponding to TO in the edge information table for the node ID of the processing target node (S11). In addition, the determination unit 14b counts the number of rows (the number of output edges) corresponding to the FROM in the edge information table for the node ID of the processing target node (S12).

Next, the determination unit 14b refers to the input edge number constraint and the output edge number constraint of the corresponding row in the node individual constraint information for the node type of the processing target node (S13), and if the number of input edges counted in S11 falls within a range of the input edge number constraint (S14: Yes), the processing proceeds to S16. On the other hand, if the number of input edges counted in S11 does not fall within the range of the input edge number Constraint (S14: No), the determination unit 14b records that there is an error in the number of input edges with respect to the node ID of the processing target node (S15), and the processing proceeds to S16.

In S16, if the number of output edges falls within a range of the output edge number constraint (S16: Yes), the processing of the determination unit 14b proceeds to processing of the next row in the node information table. On the other hand, if the number of output edges does not fall within the range of the output edge number constraint in S16 (S16: No), it is recorded that there is an error in the number of output edges with respect to the node ID of the processing target node (S17), and the processing proceeds to processing of the next row in the node information table.

By the determination unit 14b performing the above processing, it is possible to determine whether or not each node in the operation flow satisfies the constraint of the individual node.

### [Check of Constraint of Node Relationship]

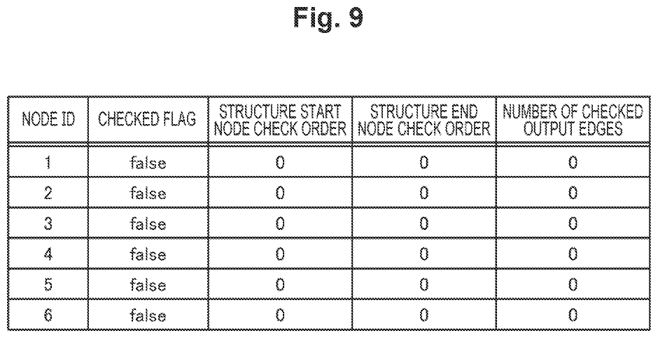

Next, an example of check of the constraint of the node relationship by the determination unit 14b will be described. The determination unit 14b uses, for example, the node relationship constraint information, the node information table and the edge information table (see FIG. 5), and the temporary information table for relationship check (see FIG. 9) to check whether or not each node of the operation flow satisfies the constraint of the node relationship (the constraint conditions of the connection relationship between the nodes).

The temporary information table for relationship check (hereinafter, referred to as a temporary information table as appropriate) is a table for storing temporary data necessary for checking the state of the node relationship.

For example, as illustrated in FIG. 9, the temporary information table is a table for recording the node ID of the node described in the node information table (see the reference numeral 502 in FIG. 5), a flag (checked flag) indicating whether or not the node of the node ID is checked, check order of the start node of the structure to be checked (structure start node check order), check order of the end node of the structure to be checked (structure end node check order), the number of checked output edges, and the like.

In the temporary information table, rows corresponding to the number of rows indicated in the node information table are prepared in an initial state, and a node ID column is set. In the temporary information table, in the initial state, false is set in the column of the checked flag, and 0 is set in the other columns.

For example, the determination unit 14b determines whether or not there are (1) a start/end combination abnormality error, (2) a nesting abnormality error, and (3) a backward error in the operation flow on the basis of the above-described node relationship constraint information.
(1) The start/end combination abnormality error is an error in which a structure start node and a structure end node paired with the structure start node do not exist in the operation flow.

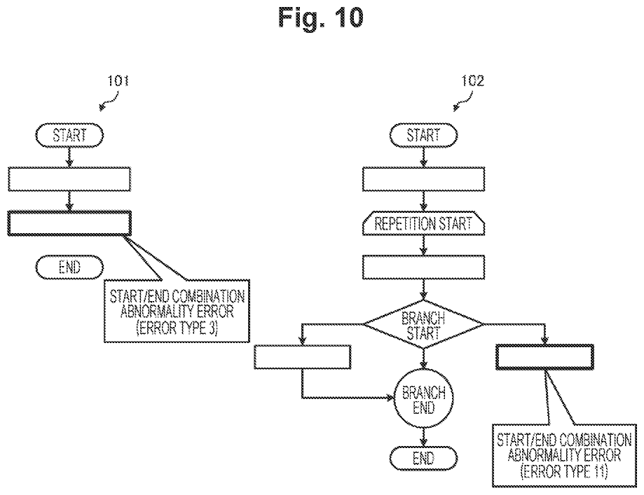

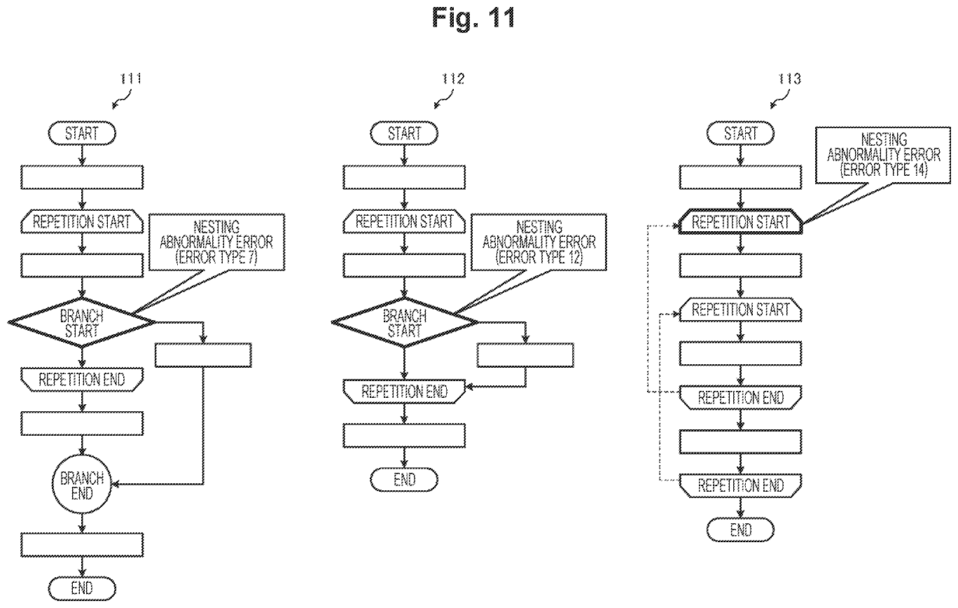

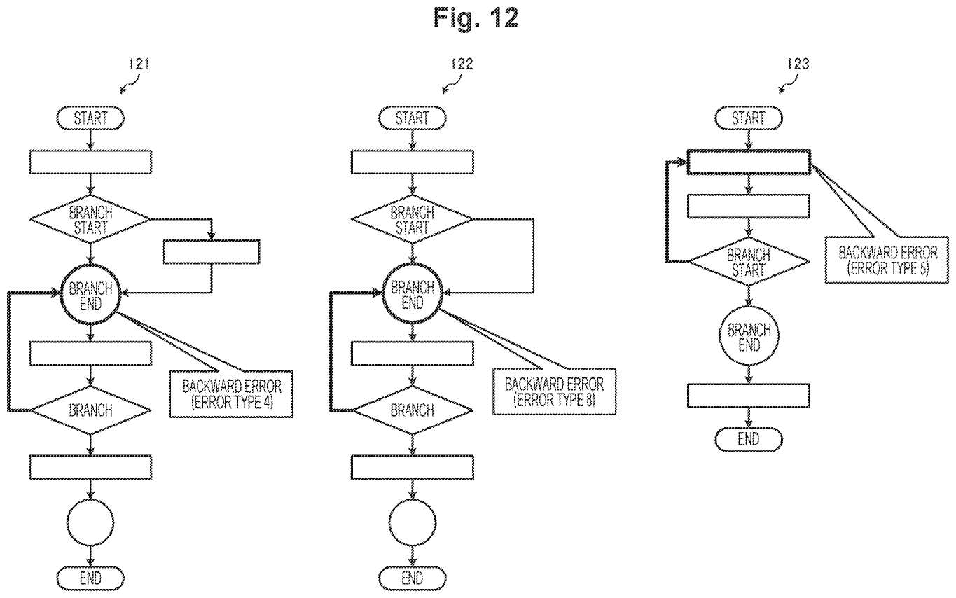

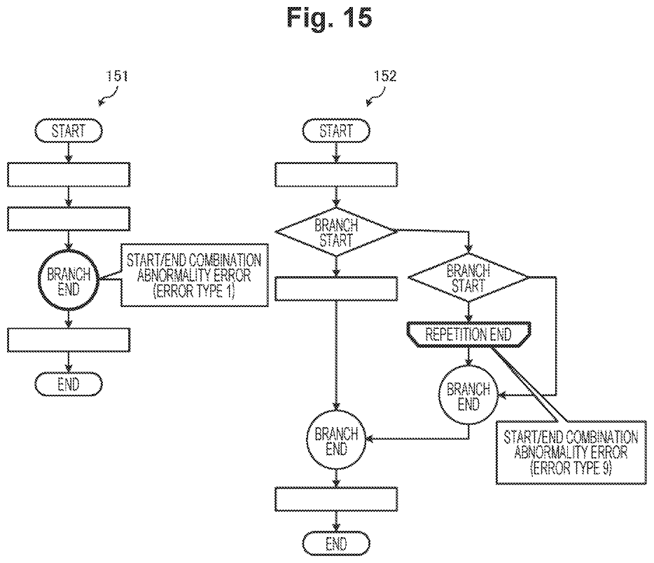

The start/end combination abnormality error is, for example, an error in which the structure start node of the operation flow exists but the flow does not reach the structure end node corresponding to the structure start node as indicated by reference numerals 101 and 102 in FIG. 10, or an error in which the structure start node corresponding to the structure end node does not exist although the operation flow reaches the structure end node as indicated by reference numerals 151 and 152 in FIG. 15.
(2) The nesting abnormality error is, for example, an error in which a plurality of structures included in the operation flow is not in a complete nested state as indicated by reference numerals 111, 112 and 113 in FIG. 11.
(3) The backward error is, for example, an error in which there is an edge (an edge indicated by a thick line in FIG. 12) that breaks the structure included in the operation flow as indicated by reference numerals 121, 122 and 123 in FIG. 12.

### Example of Processing Procedure

Next, an example of processing procedure when the editing support device 10 checks the constraint of the node relationship of the operation flow will be described. Here, a case where the editing support device 10 detects (1) a start/end combination abnormality error, (2) a nesting abnormality error, and (3) a backward error in the operation flow will be described as an example.

First, the editing support device 10 executes, for example, the following processing and performs check processing of one flow from the start to the end of the operation flow.

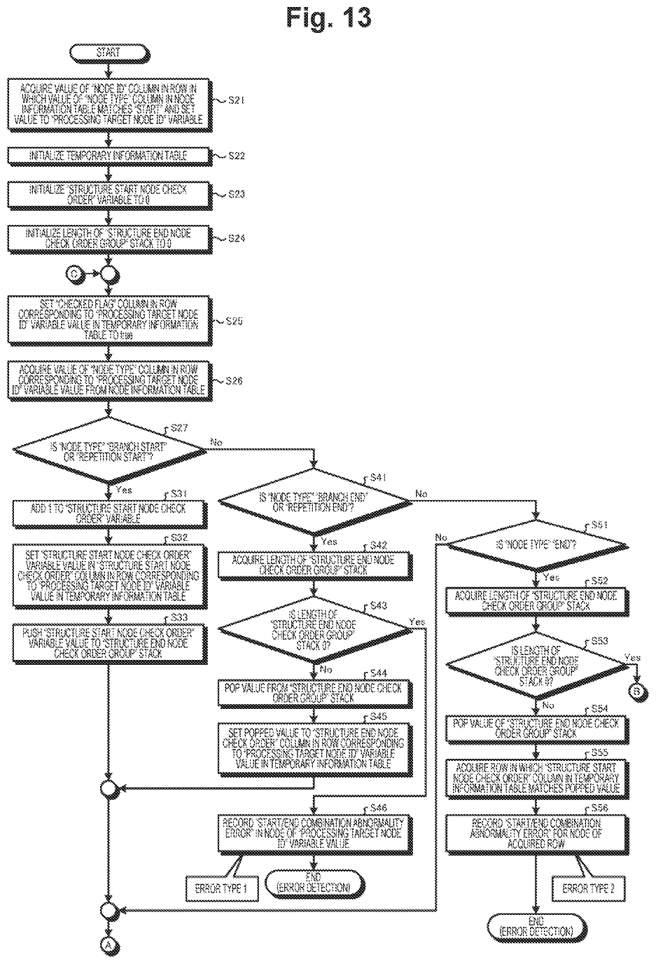

First, the determination unit 14b of the editing support device 10 specifies a start node of the operation flow. For example, the determination unit 14b acquires a value of the “node ID” column in a row in which a value of the “node type” column matches “start” in the node information table (see the reference numeral 502 in FIG. 5) and sets the value to the “processing target node ID” variable (S21 in FIG. 13).

Next, the determination unit 14b initializes the temporary information table (see FIG. 9) (S22). In addition, the determination unit 14b initializes the “structure start node check order” variable (variable indicating the check order of the structure start node) to 0 (S23). In addition, the determination unit 14b also initializes a length of the “structure end node check order group” stack (stack for managing the check order group of the structure end nodes) to 0 (S24).

Next, the determination unit 14b records that the processing target node has been checked in the temporary information table. For example, the determination unit 14b sets the “checked flag” column in the row (for example, a row of the node ID of the start node) corresponding to the “processing target node ID” variable value in the temporary information table to true (S25).

Next, the determination unit 14b acquires the value of the “node type” column in the row corresponding to the “processing target node ID” variable value from the node information table (S26).

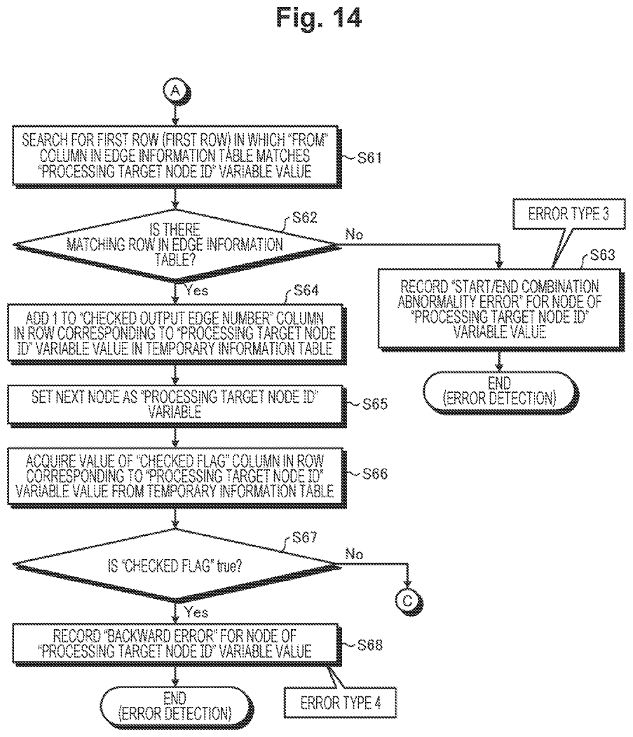

Next, if the “node type” acquired in S26 is “branch start” or “repetition start” (S27: Yes), the determination unit 14b adds 1 to the “structure start node check order” variable (S31). Then, the determination unit 14b sets the “structure start node check order” variable value added in S31 in the “structure start node check order” column in the row corresponding to the “processing target node ID” variable value in the temporary information table (S32). Thereafter, the determination unit 14b pushes the “structure start node check order” variable value added in S31 to the “structure end node check order group” stack (S33). Thereafter, the processing proceeds to S61 in FIG. 14. The processing in S61 in FIG. 14 will be described later.

On the other hand, if the “node type” acquired in S26 in FIG. 13 is “branch end” or “repetition end” (S27: No→S41: Yes), the determination unit 14b acquires a length of the “structure end node check order group” stack (S42), and if the length is not 0 (S43: No), the determination unit 14b pops the value from the “structure end node check order group” stack (S44). In other words, the determination unit 14b acquires a value at the top of the “structure end node check order group” stack.

Next, the determination unit 14b sets the value popped in S44 in the “structure end node check order” column in the row corresponding to the “processing target node ID” variable value in the temporary information table (S45). Thereafter, the processing proceeds to S61 in FIG. 14. The processing in S61 in FIG. 14 will be described later.

On the other hand, if the length of the “structure end node check order group” stack is 0 in S43 in FIG. 13 (S43: Yes), the determination unit 14b determines the “start/end combination abnormality error” for the node of the “processing target node ID” variable value. Then, the error output unit 14c records the “start/end combination abnormality error” for the node of the “processing target node ID” variable value (S46: error type 1).

As a result, the editing support device 10 can detect a start/end combination abnormality error (error type 1) of a branch end node of the operation flow as indicated by a reference numeral 151 in FIG. 15, for example. Then, the editing support device 10 can display an error message such as the “start/end combination abnormality error” for the branch end node that is a cause of the error of the operation flow.

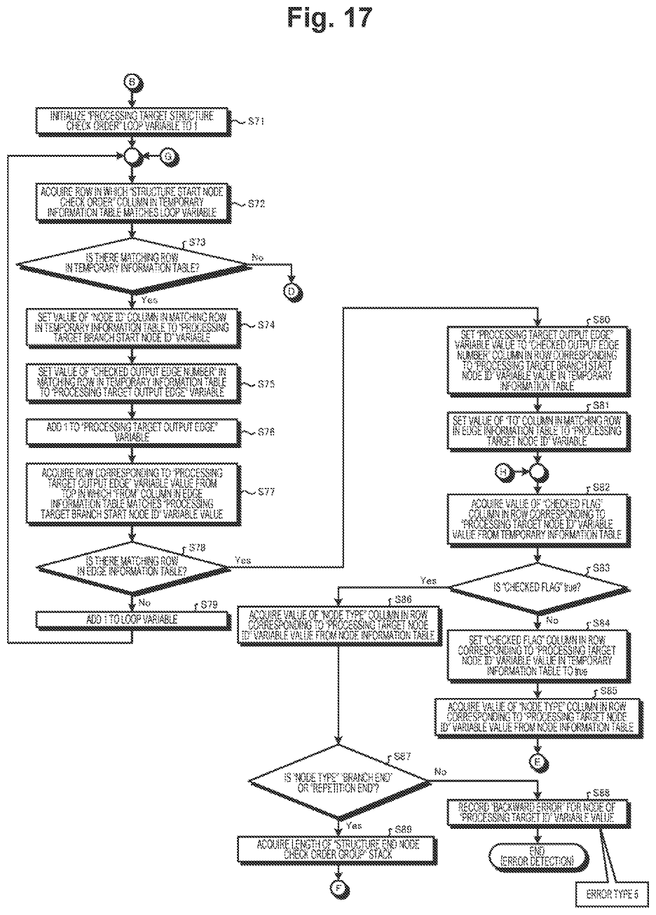

The description returns to FIG. 13. On the other hand, if the “node type” acquired in S26 in FIG. 13 is “end” (S41: No→S51: Yes), the determination unit 14b acquires a length of the “structure end node check order group” stack (S52), and if the length is not 0 (S53: No), the determination unit 14b pops the value of the “structure end node check order group” stack (S54). On the other hand, if the length of the “structure end node check order group” stack is 0 in S53 (S53: Yes), the processing proceeds to S71 in FIG. 17, The processing in S71 in FIG. 17 will be described later.

After S54 in FIG. 13, the determination unit 14b acquires a row in which the “structure start node check order” column in the temporary information table matches the value popped in S54 (S55). Then, the determination unit 14b determines the “start/end combination abnormality error” for the node in the row acquired in S55. Further, the error output unit 14c records the “start/end combination abnormality error” for the node (S56: error type 2).

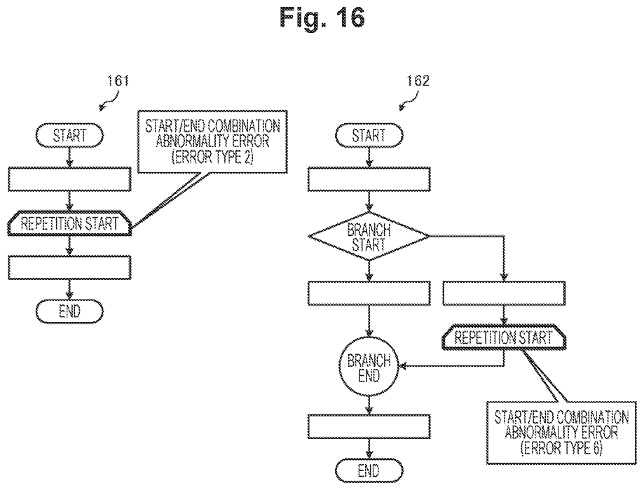

As a result, the editing support device 10 can detect a start/end combination abnormality error (error type 2) such as a case where the repetition start node is not terminated at the repetition end node in the operation flow indicated by a reference numeral 161 in FIG. 16, for example. Then, the editing support device 10 can display an error message such as the “start/end combination abnormality error” for the repetition start node that is a cause of the error of the operation flow.

On the other hand, in a case where the “node type” is none of “branch start”, “repetition start”, “branch end”, “repetition end”, and “end” in S51 in FIG. 13 (S51: No), the processing proceeds to S61 in FIG. 14.

In S61 in FIG. 14, the determination unit 14b searches for a first row (1st row) in which the “FROM” column in the edge information table matches the “processing target node ID” variable value. Then, in a case where the determination unit 14b determines that there is no matching row in the edge information table (S62: No), the determination unit 14b determines the “start/end combination abnormality error” for the node of the “processing target node ID” variable value. Then, the error output unit 14c records the “start/end combination abnormality error” for the node (S63: error type 3).

As a result, the editing support device 10 can detect a start/end combination abnormality error (error type 3) of a type in which the flow has not reached the structure end node as indicated by the reference numeral 101 in FIG. 10, for example. Then, the editing support device 10 can display an error message such as the “start/end combination abnormality error” for the node that is a cause of the error of the operation flow.

The description returns to FIG. 14. On the other hand, in S61 in FIG. 14, in a case where the determination unit 14b finds the first row (1st row) in which the “FROM” column in the edge information table matches the “processing target node ID” variable value (S62: Yes), the determination unit 14b adds 1 to the “number of checked output edges” column in the row corresponding to the “processing target node ID” variable value in the temporary information table (S64).

Next, the determination unit 14b sets the next node (a value of TO in the row searched from the edge information table in S61) as the “processing target node ID” variable value (S65). Then, the determination unit 14b acquires the value of the “checked flag” column in the row corresponding to the “processing target node ID” variable value from the temporary information table (S66). If the “checked flag” acquired in S66 is true (S67: Yes), the determination unit 14b determines the “backward error” for the node of the “processing target node ID” variable value. Then, the error output unit 14c records the “backward error” for the node (S68: error type 4).

As a result, the editing support device 10 can detect, for example, a loop error (error type 4) as indicated by a reference numeral 121 in FIG. 12. Then, the editing support device 10 can display an error message such as the “loop error” for the node that is a cause of the error of the operation flow.

If the “checked flag” acquired in S66 in FIG. 14 is false (S67; No), the processing returns to S25 in FIG. 13.

Next, processing in S71 and subsequent processing in FIG. 17 will be described. In the processing in S71 and subsequent processing, the determination unit 14b processes the structures in the operation flow in the order of the structure start node check. In addition, if there is a branch path (that is, a second or subsequent branch path) that has not yet been processed in the operation flow, the determination unit 14b sequentially processes the branch path. In this event, the determination unit 14b uses a loop variable (“processing target structure check order” loop variable) of the check order of each structure in order to check each structure in the operation flow.

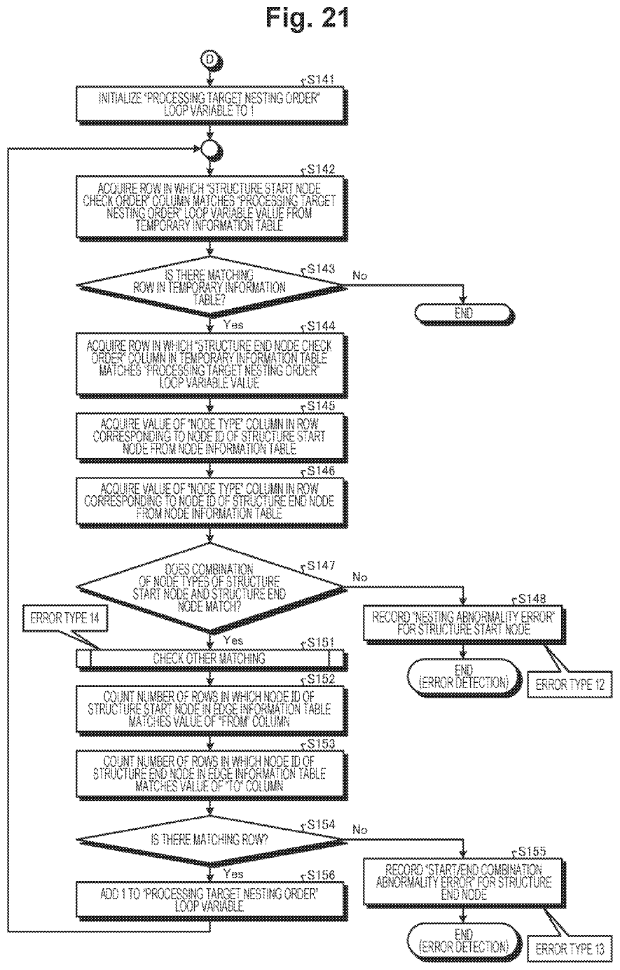

First, the determination unit 14b initializes the “processing target structure check order” loop variable to 1 (S71). Next, the determination unit 14b acquires a row in which the “structure start node check order” column matches the loop variable from the temporary information table (S72), Here, if there is a matching row in the temporary information table (S73: Yes), the processing proceeds to S74. On the other hand, if there is no matching row in the temporary information table (S73: No), the processing proceeds to S141 in FIG. 21. The processing in S141 in FIG. 21 will be described later.

In S74 in FIG. 17, the determination unit 14b sets the value in the “node ID” column in the matching row in the temporary information table to the “processing target branch start node ID” variable. Then, the determination unit 14b sets the value in the “checked output edge number” column in the matching row in the temporary information table to the “processing target output edge” variable (S75). Thereafter, the determination unit 14b adds 1 to the “processing target output edge” variable (S76).

Next, the determination unit 14b acquires a row in which the “FROM” column in the edge information table matches the “processing target branch start node ID” variable value and is corresponding to the “processing target output edge” variable value from the top (S77). Here, if there is no matching row in the edge information table (S78: No), the determination unit 14b adds 1 to the loop variable (S79), and the processing returns to S72.

On the other hand, in a case where there is a matching row in the edge information table in S78 (S78: Yes), the determination unit 14b sets the “processing target output edge” variable value in the “checked output edge number” column in the row corresponding to the “processing target branch start node ID” variable value in the temporary information table (S80). Then, the determination unit 14b sets the value of the “TO” column in the matching row in the edge information table to the “processing target node ID” variable (S81).

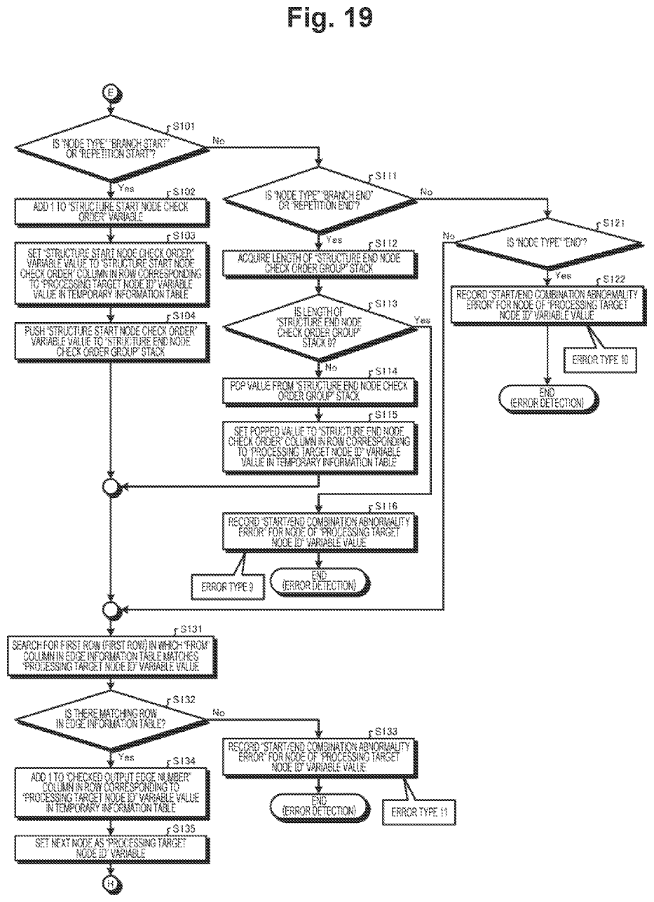

Next, the determination unit 14b acquires the value of the “checked flag” column in the row corresponding to the “processing target node ID” variable value from the temporary information table (S82). If the value acquired in S82 is not true (S83: No), the determination unit 14b sets the “checked flag” column in the row corresponding to the “processing target node ID” variable value in the temporary information table to true (S84). Thereafter, the determination unit 14b acquires the value in the “node type” column in the row corresponding to the “processing target node ID” variable value from the node information table (S85), and the processing proceeds to S101 in FIG. 19. The processing in S101 in FIG. 19 will be described later.

On the other hand, if the value acquired in S82 in FIG. 17 is true (S83: Yes), the determination unit 14b acquires the value in the “node type” column in the row corresponding to the “processing target node ID” variable value from the node information table (S86). If the node type acquired in S86 is neither “branch end” nor “repetition end” (S87: No), the determination unit 14b determines the “backward error” for the node of the “processing target node ID” variable value. Then, the error output unit 14c records the “backward error” for the node (S88: error type 5).

As a result, the editing support device 10 can detect a backward error (error type 5) as indicated by a reference numeral 123 in FIG. 12, for example. Then, the editing support device 10 can display an error message such as the “backward error” for the node that is a cause of the error of the operation flow.

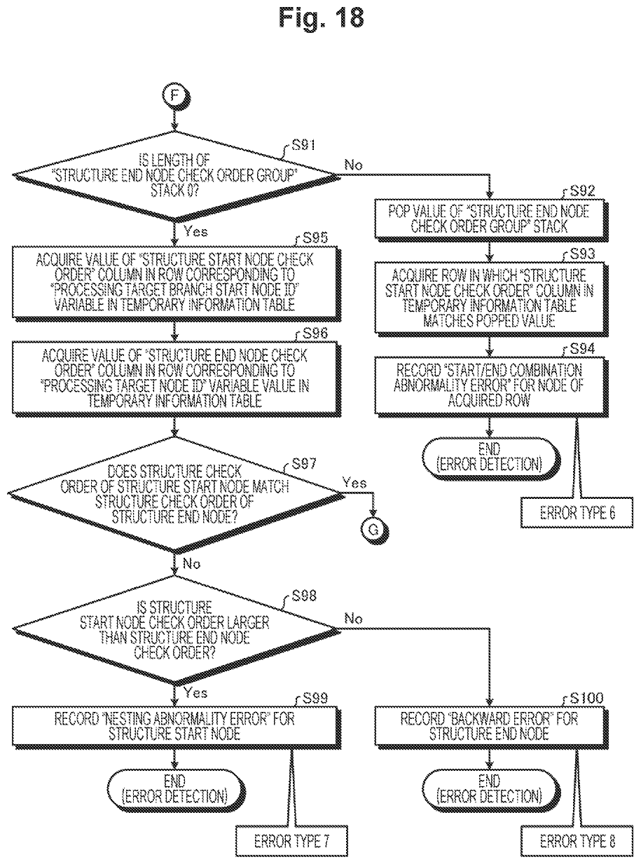

On the other hand, if the node type acquired in S86 in FIG. 17 is “branch end” or “repetition end” (887: Yes), the determination unit 14b acquires a length of the “structure end node check order group” stack (S89), and if the length is not 0 (S91; No in FIG. 18), the determination unit 14b pops the value of the “structure end node check order group” stack (S92). Next, the determination unit 14b acquires a row in which the “structure start node check order” column in the temporary information table matches the value popped in S92 (S93), Then, the determination unit 14b determines the “start/end combination abnormality error” for the node in the row acquired in S93. Further, the error output unit 14c records the “start/end combination abnormality error” for the node (S94: error type 6).

As a result, the editing support device 10 can detect a start/end combination abnormality error (error type 6) in the branch path as indicated by a reference numeral 162 in FIG. 16, for example. Then, the editing support device 10 can display an error message such as the “start/end combination abnormality error” for the node (for example, the repetition start node) that is a cause of the error of the operation flow.

On the other hand, if the length of the “structure end node check order group” stack is 0 in S91 in FIG. 18 (S91: Yes), the determination unit 14b acquires the value of the “structure start node check order” column in the row corresponding to the “processing target branch start node ID” variable in the temporary information table (S95).

In addition, the determination unit 14b acquires a value in the “structure end node check order” column in the row corresponding to the “processing target node ID” variable value in the temporary information table (S96).

Then, the determination unit 14b determines whether or not the structure check order of the structure start node matches the structure check order of the structure end node (S97). In other words, the determination unit 14b determines whether or not the structure start node check order acquired in S95 matches the structure end node check order acquired in S96. Here, in a case where the determination unit 14b determines that the structure start node check order matches the structure end node check order (897: Yes), the processing returns to S72 in FIG. 17.

On the other hand, in a case where the structure start node check order does not match the structure end node check order (S97: No), the determination unit 14b determines whether or not the value of the structure start node check order is larger than the value of the structure end node check order (S98).

Here, in a case where the determination unit 14b determines that the value of the structure start node check order is larger than the value of the structure end node check order (S98: Yes), the determination unit 14b determines the “nesting abnormality error” for the structure start node. Then, the error output unit 14c records the “nesting abnormality error” for the node (S99: error type 7).

As a result, the editing support device 10 can detect, for example, a nesting abnormality error (error type 7) as indicated by a reference numeral 111 in FIG. 11. Then, the editing support device 10 can display an error message such as the “nesting abnormality error” for the node (for example, a branch start node) that is a cause of the error of the operation flow.

On the other hand, in S98 in FIG. 18, in a case where the structure start node check order is smaller than the structure end node check order (S98: No), the determination unit 14b determines the “backward error” for the structure end node. Then, the error output unit 14c records the “backward error” for the node (S100: error type 8).

As a result, the editing support device 10 can detect a backward error (error type 8) as indicated by a reference numeral 122 in FIG. 12, for example. Then, the editing support device 10 can display an error message such as the “backward error” for the node (for example, a branch end node) that is a cause of the error of the operation flow.

Next, processing in S101 and subsequent processing in FIG. 19 will be described. If the “node type” corresponding to the “processing target node ID” variable value acquired from the node information table in S85 in FIG. 17 is “branch start” or “repetition start” (S101: Yes in FIG. 19), the determination unit 14b performs the same processing as that in S31 to S33 in FIG. 13 described above.

In other words, the determination unit 14b adds 1 to the “structure start node check order” variable (S102 in FIG. 19). Then, the determination unit 14b sets the “structure start node check order” variable value added in S102 in the “structure start node check order” column in the row corresponding to the “processing target node ID” variable value in the temporary information table (S103).

Thereafter, the determination unit 14b pushes the “structure start node check order” variable added in S102 to the “structure end node check order group” stack (S104). Thereafter, the processing proceeds to S131.

On the other hand, if the value of the “node type” acquired in S85 in FIG. 17 is “branch end” or “repetition end” (S101: No in FIG. 19→S111: Yes), the determination unit 14b performs the same processing as that in S42 to S45 in FIG. 13 described above.

In other words, the determination unit 14b acquires a length of the “structure end node check order group” stack (S112 in FIG. 19), and if the length is not 0 (S113: No), pops the value from the “structure end node check order group” stack (S114).

Thereafter, the determination unit 14b sets the value popped in S114 in the “structure end node check order” column in the row corresponding to the “processing target node ID” variable value in the temporary information table (S115). Thereafter, the processing proceeds to S131.

On the other hand, if the length of the “structure end node check order group” stack is 0 in S113 (S113: Yes), the determination unit 14b determines the “start/end combination abnormality error” for the node of the “processing target node ID” variable value. Then, the error output unit 14c records the “start/end combination abnormality error” for the node of the “processing target node ID” variable value (S116: error type 9).

As a result, the editing support device 10 can detect a start/end combination abnormality error (error type 9) in the branch path of the operation flow as indicated by a reference numeral 152 in FIG. 15, for example. Then, the editing support device 10 can display an error message such as the “start/end combination abnormality error” for the node (for example, the repetition end node) that is a cause of the error of the operation flow.

The description returns to FIG. 19. On the other hand, if the “node type” acquired in S85 in FIG. 17 is “end” (S111: No→S121: Yes), the determination unit 14b determines the “start/end combination abnormality error” for the node of the “processing target node ID” variable value. Then, the error output unit 14c records the “start/end combination abnormality error” for the node (S122: error type 10).

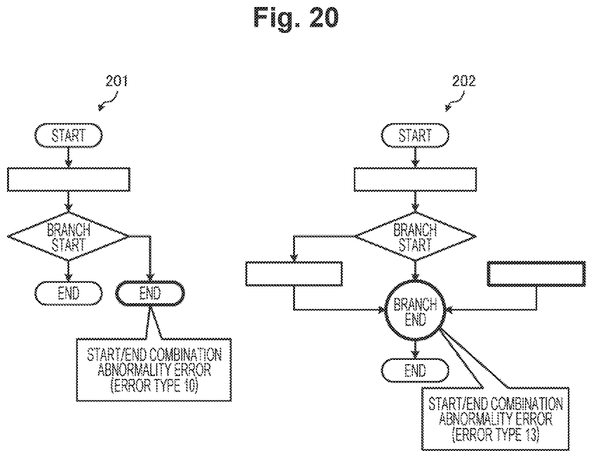

As a result, the editing support device 10 can detect a start/end combination abnormality error (error type 10) in the branch path, for example, as indicated by a reference numeral 201 in FIG. 20. Then, the editing support device 10 can display an error message such as the “start/end combination abnormality error” for the node (for example, the end node) that is a cause of the error of the operation flow.

The description returns to FIG. 19. In a case where the type of the node is none of “branch start”, “repetition start”, “branch end”, “repetition end”, and “end” in S121 in FIG. 19 (S121: No), the processing proceeds to S131.

In S131, the determination unit 14b searches for a first row (1st row) in which the “FROM” column in the edge information table matches the “processing target node ID” variable value (S131). Then, in a case where the determination unit 14b determines that there is no matching row in the edge information table (S132: No), the determination unit 14b determines the “start/end combination abnormality error” for the node with the “processing target node ID” variable value. Then, the error output unit 14c records the “start/end combination abnormality error” for the node (S133: error type 11).

As a result, the editing support device 10 can detect a start/end combination abnormality error (error type 11) in the branch path, for example, as indicated by a reference numeral 102 in FIG. 10. Then, the editing support device 10 can display an error message such as the “start/end combination abnormality error” for the node that is a cause of the error of the operation flow.

The description returns to FIG. 19. On the other hand, in S132 in FIG. 19, in a case where the determination unit 14b finds a first row (1st row) in which the “FROM” column in the edge information table matches the “processing target node ID” variable value (S132: Yes), the determination unit 14b adds 1 to the number of checked output edges in the row corresponding to the “processing target node ID” variable value in the temporary information table (S134). Then, the determination unit 14b sets the next node (the value of TO in the row searched from the edge information table in S131) as the “processing target node ID” variable (S135). Thereafter, the processing returns to S82 in FIG. 17.

Next, processing in S141 and subsequent processing in FIG. 21 will be described with reference to FIG. 21. In the processing in S141 and subsequent processing, the determination unit 14b detects a nesting abnormality error by checking a relationship between the structure start node and the structure end node in the structure found from the operation flow. In this event, the determination unit 14b uses the “processing target nesting order” loop variable in order to check nesting in the operation flow.

First, the determination unit 14b initializes the “processing target nesting order” loop variable to 1 (S141). Next, the determination unit 14b acquires a row in which the “structure start node check order” column matches the “processing target nesting order” loop variable value from the temporary information table (S142). Here, if there is a matching row in the temporary information table (S143: Yes), the processing proceeds to S144. On the other hand, if there is no matching row in the temporary information table (S143: No), the processing ends.

In S144, the determination unit 14b acquires a row in which the “structure end node check order” column matches the “processing target nesting order” loop variable value from the temporary information table (S144).

Next, the determination unit 14b acquires a value of the “node type” column in the row corresponding to the node ID of the structure start node from the node information table (S145).

In addition, the determination unit 14b acquires a value of the “node type” column in the row corresponding to the node ID of the structure end node from the node information table (S146).

Then, the determination unit 14b determines whether or not a combination of the node types of the structure start node and the structure end node matches (S147), and if the combination does not match (S147: No), the determination unit 14b determines the “nesting abnormality error” for the structure start node. Then, the error output unit 14c records the “nesting abnormality error” for the node (S148: error type 12).

As a result, the editing support device 10 can detect, for example, a nesting abnormality error (error type 12) as indicated by a reference numeral 112 in FIG. 11. Then, the editing support device 10 can display an error message such as the “nesting abnormality error” for the node (for example, a branch start node) that is a cause of the error of the operation flow.

The description returns to FIG. 21. On the other hand, in S147 in FIG. 21, in a case where the combination of the node types of the structure start node and the structure end node in the operation flow matches (S147: Yes), the determination unit 14b performs another matching check (S151; error type 14).

For example, as a result of the check, if it is detected that the combination of the node types of the structure start node and the structure end node is the same but the structures is not completely nested as indicated by a reference numeral 113 in FIG. 11, the determination unit 14b determines the “nesting abnormality error” for the structure start node (error type 14). Then, the error output unit 14c records the “nesting abnormality error” for the node (for example, the repetition start node).

After S151 in FIG. 21, the determination unit 14b counts the number of rows in which the node ID of the structure start node in the edge information table matches the value in the “FROM” column (S152). In other words, the determination unit 14b counts the number of output edges from the structure start node.

In addition, the determination unit 14b counts the number of rows in which the node ID of the structure end node in the edge information table matches the value in the “TO” column (S153). In other words, the determination unit 14b counts the number of input edges to the structure end node.

Then, the determination unit 14b determines whether or not the number of rows counted in S152 matches the number of rows counted in S153 (S154: Is there matching row?). In other words, the determination unit 14b determines whether or not the number of output edges from the structure start node matches the number of input edges to the structure end node. Here, in a case where the determination unit 14b determines that the number of output edges from the structure start node does not match the number of input edges to the structure end node (S154: No), the determination unit 14b determines the “start/end combination abnormality error” for the structure end node. Then, the error output unit 14c records the “start/end combination abnormality error” for the node (S155: error type 13).

As a result, the editing support device 10 can detect a start/end combination abnormality error (error type 13) of a type in which the number of output edges from the structure start node (for example, the branch start node) does not match the number of input edges to the structure end node (for example, the branch end node) as indicated by a reference numeral 202 in FIG. 20, for example. Then, the editing support device 10 can display an error message such as the “start/end combination abnormality error” for the node (for example, the branch end node) that is a cause of the error of the operation flow.

In a case where the determination unit 14b determines that the number of output edges from the structure start node matches the number of input edges to the structure end node in S154 in FIG. 21 (S154: Yes), the determination unit 14b adds 1 to the loop variable (S156), and the processing returns to S142.

The editing support device 10 outputs the recorded error of the operation flow after the above processing. As a result, the editing support device 10 can detect various errors including an error in which the nested state of the control structure of the operation flow is incomplete from the operation flow to be processed. In addition, the editing support device 10 can specify a node that is a cause of an error in the operation flow as an error node and output information on the specified error node. As a result, the editing support device can present an error portion of the operation flow to the user, so that the user can easily correct the operation flow to meet the constraint of the RPA scenario.

### Other Embodiments

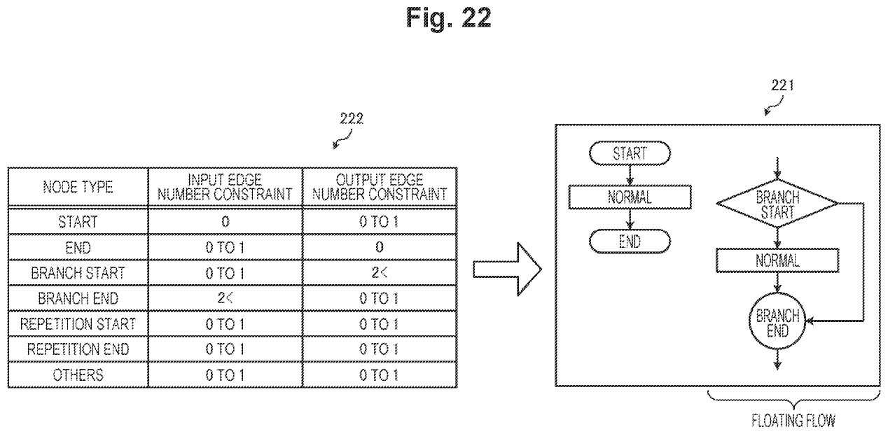

Note that the editing support device 10 may check the constraint of the individual node after permitting the operation flow to include floating flow (flow not connected between the start and the end) as indicated by a reference numeral 201 in FIG. 22. In this case, the editing support device 10 uses, for example, node individual constraint information indicated by a reference numeral 222. In this way, the editing support device 10 can also check the constraint of the individual node for the operation flow including the floating flow.

### [System Configuration, and the Like]

Moreover, each component of each unit illustrated is functionally conceptual and does not necessarily need to be physically configured as illustrated. In other words, specific forms of distribution and integration of devices are not limited to the illustrated forms, and some or all of the devices can be functionally or physically distributed and integrated in any units according to various loads, usage conditions, and the like. Further, some or all of the processing functions to be performed in the devices can be implemented by a CPU and a program to be executed by the CPU or can be implemented as hardware by wired logic.

In the processing described in the above-described embodiments, some or all kinds of the processing described as being automatically performed may be manually performed, or some or all kinds of the processing described as being manually performed may be automatically performed by a known method. In addition, the processing procedure, the control procedure, the specific names, and the information including various data and parameters illustrated in the above document and drawings can be arbitrarily changed unless otherwise specified.

### [Program]

The above editing support device 10 can be implemented by installing a program (editing support program) as package software or online software in a desired computer. For example, by causing an information processing apparatus to execute the above program, the information processing apparatus can be caused to function as the editing support device 10. Here, the information processing apparatus also includes mobile communication terminals such as a smartphone, a mobile phone, and a personal handy-phone system (PHS) and terminals such as a personal digital assistant (PDA).

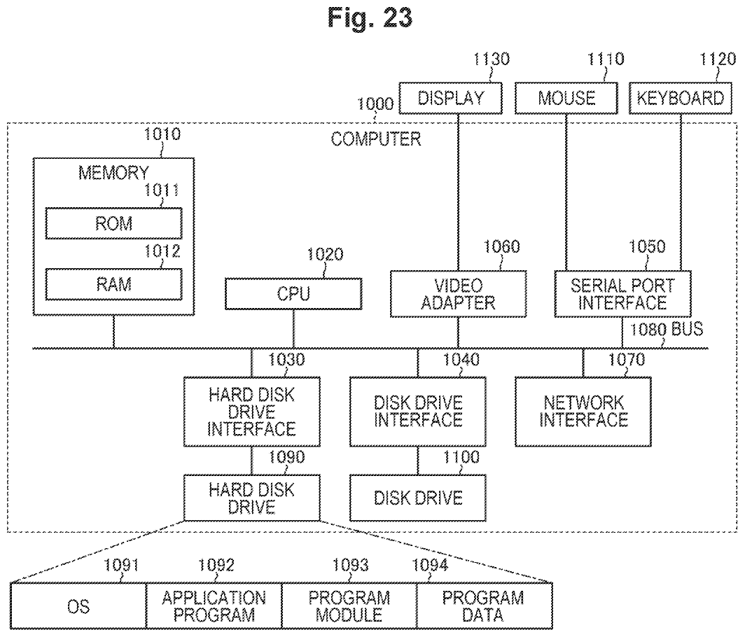

FIG. 23 is a view illustrating an example of a computer that executes an editing support program. A computer 1000 includes a memory 1010 and a CPU 1020, for example. In addition, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to, for example, a display 1130.

The hard disk drive 1090 stores, for example, an OS 1091, an application program 1092, a program module 1093, and program data 1094. In other words, the program that defines each processing to be executed by the editing support device 10 is implemented as a program module 1093 in which a code executable by a computer is described. The program module 1093 is stored in, for example, the hard disk drive 1090. For example, the program module 1093 for executing processing similar to the functional configuration in the editing support device 10 is stored in the hard disk drive 1090. Note that the hard disk drive 1090 may be replaced with a solid state drive (SSD).

Data to be used in the processing of the above embodiments is stored as the program data 1094 in, for example, the memory 1010 or the hard disk drive 1090. Then, the CPU 1020 reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

### REFERENCE SIGNS LIST

10 Editing support device
11 Communication processing unit
12 Input unit
13 Output unit
14 Control unit
14a Input acceptance unit
14b Determination unit
14c Error output unit
15 Storage unit

1. An editing support device comprising:
an input acceptance unit, including one or more processors, configured to accept input of operation flow indicating a series of operations on a computer by nodes indicating the operations and an edge connecting the nodes;
a determination unit, including one or more processors, configured to determine whether or not a nested state of a control structure of the operation flow is in an incomplete state on a basis of a connection relationship between the nodes of the operation flow and determine that an error is included in the operation flow in a case where it is determined that the nested state is in the incomplete state; and
an error output unit, including one or more processors, configured to specify, in a case where it is determined that an error is included in the operation flow, a node that is a cause of the error in the operation flow as an error node and output information on the specified error node.

2. The editing support device according to claim 1,
wherein, in a case where the operation flow includes an edge corresponding to goto, the determination unit is configured to determine that nesting of the control structure is in an incomplete state.

3. The editing support device according to claim 1,
wherein the determination unit is configured to determine that an error is included in the operation flow in a case where a backward error is included in the operation flow or a start/end combination abnormality error is included in the operation flow.

4. The editing support device according to claim 1, wherein the determination unit is configured to:
determine whether or not a number of input edges and a number of output edges permitted for a type of node are satisfied for each type of node of the operation flow, and
determine that an error is included in the operation flow in a case where there is a node that does not satisfy the number of input edges and the number of output edges permitted for the type of node, and
the error output unit is configured to specify a node that does not satisfy the number of input edges and the number of output edges permitted for the type of node as an error node and outputs the error node.

5. The editing support device according to claim 1,
wherein at the error output unit, the information on the error node includes information indicating a cause of the error.

6. An editing support method to be executed by an editing support device, the method comprising:
accepting input of operation flow indicating a series of operations on a computer by nodes indicating the operations and an edge connecting the nodes;
determining whether or not a nested state of a control structure of the operation flow is in an incomplete state on a basis of a connection relationship between the nodes of the operation flow and determining that an error is included in the operation flow in a case where it is determined that the nested state is in the incomplete state; and
specifying, in a case where it is determined that an error is included in the operation flow, a node which is a cause of the error in the operation flow as an error node and outputting information on the specified error node.

7. A non-transitory computer-readable medium storing software comprising instructions executable by one or more computers which, upon such execution, cause the one or more computers to perform operations comprising:
accepting input of operation flow indicating a series of operations on a computer by nodes indicating the operations and an edge connecting the nodes;
determining whether or not a nested state of a control structure of the operation flow is in an incomplete state on a basis of a connection relationship between the nodes of the operation flow and determining that an error is included in the operation flow in a case where it is determined that the nested state is in the incomplete state; and
specifying, in a case where it is determined that an error is included in the operation flow, a node which is a cause of the error in the operation flow as an error node and outputting information on the specified error node.
